(19) United States
(12) Patent Application Publication
(10) Pub. No.: US 2012/0196534 A1
(43) Pub. Date: Aug. 2, 2012

(54) METHOD, APPARATUS, AND COMPUTER PROGRAM PRODUCT FOR BROADCASTING IN SHORT-RANGE COMMUNICATION

(75) Inventors: Mika KASSLIN, Espoo (FI); Miika Laaksonen, Espoo (FI)

(73) Assignee: Nokia Corporation, Espoo (FI)

(21) Appl. No.: 13/018,608

(22) Filed: Feb. 1, 2011

(51) Int. Cl. H04B 7/00

(52) U.S. Cl. 455/41.2

(57) ABSTRACT

Method, apparatus, and computer program product example embodiments establish a broadcast operating mode on a Bluetooth Low Energy data channel by creating operating parameters for a data channel broadcast connection. Then data channel broadcast connection parameters are transmitted to other devices indicating the data channel broadcast connection and the operating parameters associated with the data channel broadcast connection are transmitted on a Bluetooth Low Energy advertising channel. Then information on the Bluetooth Low Energy data channel broadcast connection to the other devices, according to the operating parameters associated with the data channel broadcast connection. The bit rate of the Bluetooth Low Energy data channel used for broadcasting is not constrained by the required limits placed on the bit rate in the Bluetooth Low Energy advertising channels.

### FIELD

The field of the invention relates to wireless short-range communication and more particularly to broadcasting short-range communication content to any point.

### BACKGROUND

Modern society has adopted, and is becoming reliant upon, wireless communication devices for various purposes, such as, connecting users of the wireless communication devices with other users. Wireless communication devices can vary from battery powered handheld devices to stationary household and/or commercial devices utilizing electrical network as a power source. Due to rapid development of the wireless communication devices a number of areas capable of enabling entirely new types of communication applications have emerged.

An example of a wireless short-range communication technology is Bluetooth communication protocol, which operates in the 2.4 GHz ISM band. Bluetooth is a short-range radio network, originally intended as a cable replacement. Bluetooth Technical Specifications are published by the Bluetooth SIG, Inc. Bluetooth Specification version 2.0+EDR, published Oct. 15, 2004 has the original functional characteristics of the first version Bluetooth Basic Rate (BR) and adds the Enhanced Data Rate (EDR) feature. Bluetooth Specification version 2.1+EDR, published Jul. 26 2007 for Basic Rate/Enhanced Data Rate (BR/EDR), added definitions for new features: Encryption Pause Resume, Erroneous Data reporting, Extended Inquiry Response, Link Supervision Timeout Event, Packet Boundary Flag, Secure Simple Pairing, Sniff Subrating. Bluetooth Specification version 3.0+HS, published Apr. 21 2009, updated the standard to integrate the Alternate MAC/PHY and Unicast Connectionless Data features.

On Apr. 20, 2009, Bluetooth SIG presented the new Bluetooth Low Energy protocol. Bluetooth Low Energy (LE) is a communication protocol directed to optimize power consumption of devices while being connected to other devices. The Bluetooth Low Energy packets include a preamble used for radio synchronization, an access address used for physical link identification, a shorter protocol data unit (PDU) to carry the payload data and the PDU header information, and a cyclic redundancy code (CRC) to ensure correctness of the data in the PDU.

On Jun. 30, 2010, the Bluetooth SIG published the Bluetooth Core Specification, Version 4.0 (incorporated herein by reference), which includes the Bluetooth Low Energy (LE) protocol for products that require lower power consumption, lower complexity, and lower cost than would be possible using the BR/EDR protocol. Bluetooth LE is designed for applications requiring lower data rates and shorter duty cycles, with a very-low power idle mode, a simple device discovery, and short data packets. Bluetooth LE devices employ a star topology, where one device serves as a master for a plurality of slave devices, the master dictating connection timing by establishing the start time of the first connection event and the slave devices transmitting packets only to the master upon receiving a packet from the master. According to Bluetooth LE communication protocol all connections are point-to-point connections between two devices (the master and the slave).

### SUMMARY

In an example embodiment of the invention, a device that wishes to establish a broadcast operating mode on a Bluetooth Low Energy data channel, begins by creating operating parameters for a data channel broadcast connection.

Non-limiting examples of operating parameters for a data channel broadcast connection, that may be applied to transmitting operations, include example operating parameters for a transmit-only mode that blocks any incoming messages from the data channel receiver, a transmit-only mode that accepts flow control information from the data channel receiver, a transmit-only mode with initial setup for encryption and message authentication, and the like.

Non-limiting examples of operating parameters for a data channel broadcast connection, that may be applied to receiving operations, include example operating parameters for a receive-only mode that blocks replies to the data channel sender; a receive-only mode with flow control information allowed back to the data channel sender; a receive-only mode with initial setup for encryption and message authentication, a receive-only mode that blocks transmissions on all channels (but allows scanning on advertising channels); a receive-only mode that blocks replies to the data channel sender and prohibits scanning on any advertising channels, and the like.

In an example embodiment of the invention, the example device then transmits to other devices on a Bluetooth Low Energy advertising channel, one or more non-connectable undirected advertising channel messages with data channel broadcast connection parameters indicating the data channel broadcast connection and the operating parameters associated with the data channel broadcast connection.

Non-limiting examples of data channel broadcast connection parameters indicating the data channel broadcast connection, include information related to the physical channel and timing of the connection event, such as a channel map indicating used and unused data channels, a hop increment used in data channel selection, a channel index for the advertised connection event, a start time or transmission window for the advertised connection event, and the like.

In an example embodiment of the invention, the example device then transmits in the broadcast operating mode, information on the Bluetooth Low Energy data channel broadcast connection to the other devices, according to the operating parameters associated with the data channel broadcast connection.

The bit rate of the Bluetooth Low Energy data channel used for broadcasting is not constrained by the required limits placed on the bit rate in the Bluetooth Low Energy advertising channels.

In an example embodiment of the invention, the other devices receiving from the transmitting device, the one or more non-connectable undirected advertising channel messages, determine whether the one or more non-connectable undirected advertising channel messages include data channel broadcast connection parameters indicating a Bluetooth Low Energy data channel broadcast connection and operating parameters associated with the data channel broadcast connection.

In an example embodiment of the invention, the receiving devices may adopt the operating parameters from the one or more received advertising messages when the one or more non-connectable undirected advertising channel messages include data channel broadcast connection parameters indicating a Bluetooth Low Energy data channel broadcast connection and operating parameters associated with the data channel broadcast connection.

In an example embodiment of the invention, the receiving devices that adopt the operating parameters, may then receive the information on the Bluetooth Low Energy data channel broadcast connection according to the operating parameters associated with the data channel broadcast connection.

In this manner, the Bluetooth Low Energy protocol will have the capability to enable a single device to operate as a broadcasting node on a Bluetooth Low Energy data channel and the bit rate of a broadcasted data channel message will not be constrained by the required limits placed on the bit rate in the Bluetooth Low Energy advertising channels.

According to an example embodiment of the invention, a method comprises:

creating, at an apparatus, operating parameters for a data channel broadcast connection;

transmitting, by the apparatus, one or more non-connectable undirected advertising channel messages indicating the data channel broadcast connection and the operating parameters associated with the data channel broadcast connection; and

transmitting, by the apparatus, information on the data channel broadcast connection according to the operating parameters associated with the data channel broadcast connection.

In an example embodiment of the invention, the apparatus is in transmit-only mode while transmitting the information on the data channel broadcast connection.

In an example embodiment of the invention, the apparatus blocks any incoming messages while transmitting the information on the data channel broadcast connection.

In an example embodiment of the invention, the advertising channel message is transmitted on a Bluetooth Low Energy advertising channel and the data channel message is broadcast on a Bluetooth Low Energy data channel.

In an example embodiment of the invention, the operating parameters included in the advertising channel messages enable a receiving device to receive the information transmitted on the data channel broadcast connection.

In an example embodiment, a computer readable non-transitory medium stores program instructions, which when executed by a computer processor, performs the immediately preceding methods.

According to another example embodiment, a method comprises:

receiving, by an apparatus, one or more non-connectable undirected advertising channel messages;

determining, at the apparatus, whether the one or more non-connectable undirected advertising channel messages include an indication of a data channel broadcast connection and operating parameters associated with the data channel broadcast connection;

adopting the operating parameters from the one or more received advertising messages when the one or more non-connectable undirected advertising channel messages include an indication of a data channel broadcast connection and operating parameters associated with the data channel broadcast connection; and

receiving information on the data channel broadcast connection according to the operating parameters associated with the data channel broadcast connection.

In an example embodiment of the invention, the apparatus is in receive-only mode while receiving the information on the data channel broadcast connection.

In an example embodiment of the invention, the advertising channel message is received on a Bluetooth Low Energy advertising channel and the information is received on a Bluetooth Low Energy data channel.

In an example embodiment of the invention, the operating parameters associated with the data channel broadcast connection included in the one or more advertising channel messages enable the apparatus to receive the information on the data channel broadcast connection.

In an example embodiment of the invention, the operating parameters included in the advertising channel messages enable the apparatus to synchronize to the data channel broadcast connection to receive the information on the data channel broadcast connection.

In an example embodiment, a computer readable non-transitory medium storing program instructions, which when executed by a computer processor, performs the immediately preceding methods.

In an example embodiment, an apparatus comprises:

at least one processor;

at least one memory including computer program code;

the at least one memory and the computer program code configured to, with the at least one processor, cause the apparatus at least to:

create, at an apparatus, operating parameters for a data channel broadcast connection;

transmit, by the apparatus, one or more non-connectable undirected advertising channel messages indicating the data channel broadcast connection and the operating parameters associated with the data channel broadcast connection; and

transmit, by the apparatus, information on the data channel broadcast connection according to the operating parameters associated with the data channel broadcast connection.

In an example embodiment, an apparatus comprises:

at least one processor;

at least one memory including computer program code;

the at least one memory and the computer program code configured to, with the at least one processor, cause the apparatus at least to:

receive, by an apparatus, one or more non-connectable undirected advertising channel messages;

determine, at the apparatus, whether the one or more non-connectable undirected advertising channel messages include an indication of a data channel broadcast connection and operating parameters associated with the data channel broadcast connection;

adopt the operating parameters from the one or more received advertising messages when the one or more non-connectable undirected advertising channel messages include an indication of a data channel broadcast connection and operating parameters associated with the data channel broadcast connection; and receive information on the data channel broadcast connection according to the operating parameters associated with the data channel broadcast connection.

Accordingly, wireless communication devices are capable of broadcasting a data channel message on a Bluetooth Low Energy data channel.

### DESCRIPTION OF THE FIGURES

FIG. 1A is an example embodiment of a Bluetooth enabled wireless device using the Bluetooth LE protocol, according to at least one embodiment.

FIG. 1B is an example data channel broadcast connection use case for the Bluetooth LE protocol device of FIG. 1B, according to at least one embodiment.

FIG. 2A is an example embodiment of a wireless network with the Bluetooth enabled wireless device of FIG. 1B, transmitting on a Bluetooth Low Energy advertising channel to other devices, a non-connectable undirected advertising channel packet with data channel broadcast connection parameters and operating parameters for a receive-only operating mode associated with the data channel broadcast connection, according to at least one embodiment.

FIG. 2B is an example embodiment of the wireless network of FIG. 2A, wherein the other devices receive the broadcast data channel packet in a receive-only mode, according to at least one embodiment.

FIG. 2C is a state diagram of the Link Layer (LL) that is modified to allow the Link Layer to transition from the Standby State directly to the Connection State, according to at least one embodiment.

FIG. 2D is a mapping of RF channels to Bluetooth Low Energy data channels and Bluetooth Low Energy advertising channels, according to at least one embodiment.

FIG. 3A is an example packet structure of the advertising channel packet indicating data channel broadcast connection parameters and operating parameters for a receive-only operating mode associated with the data channel broadcast connection, according to at least one embodiment.

FIG. 3B is an example format of a modified LE Advertising Report Event sent by the Link Layer (LL) to the Host Controller Interface (HCI) in the receiving device, to report that an advertisement for a data channel broadcast connection has been received with specified operating parameters, according to at least one embodiment.

FIG. 3C is an example format of a modified LE Create Connection Command issued by the Host Controller Interface (HCI) in the broadcasting device, to indicate to the Link Layer (LL) that the request is for a transmit-only operating mode for a data channel broadcast connection in the transmitting device and a receive-only operating mode for the data channel broadcast connection in the receiving device, according to at least one embodiment.

FIG. 4 is an example embodiment of a flow diagram of the method, from the point of view of the transmitting device, according to at least one embodiment.

FIG. 5 is an example embodiment of a flow diagram of the method, from the point of view of the receiving device, according to at least one embodiment.

FIG. 6 is an example embodiment of a timing diagram for advertising a data channel broadcast connection when the connection event start time is indicated with a time offset from the advertising channel packet, according to at least one embodiment.

FIG. 7 is an example embodiment of a timing diagram for advertising of a data channel broadcast connection when the connection event start time is indicated as an event start time window and window offset with the advertising channel packet as time reference, according to at least one embodiment.

### DISCUSSION OF EXAMPLE EMBODIMENTS OF THE INVENTION

The existing Bluetooth Low Energy (LE) protocol published by the Bluetooth SIG in the Bluetooth Core Specification, Version 4.0 allows only star network topology in connections, where one device serves as a master for a plurality of slave devices. The master device dictates the connection timing and communication operations of the one or more slave devices. Bluetooth LE communicates over a total of 40 RF channels, each having a bandwidth of 2 MHz. Data communication between Bluetooth LE devices occurs in 37 pre-specified data channels, of the 40 RF channels. All data connection transmissions occur in connection events wherein a point-to-point connection is established between the master device and a slave device. In the existing Bluetooth Low Energy (LE) protocol, a slave device cannot provide data through Bluetooth LE communication to any other device than the master device to which it is connected. The remaining 3 channels, of the 40 RF channels, are advertising channels used by devices to advertise their existence and capabilities. The existing Bluetooth LE protocol defines a unidirectional connectionless broadcast mode on the advertising channels. The amount of data that can be transmitted with the connectionless broadcast mode is very limited since the advertising channels are intended for infrequent device and service advertising. As new communication applications evolve requiring higher bit rates combined with minimal energy consumption, it is desirable to enable the Bluetooth LE protocol to broadcast with bit rates that can be typically achieved with point-to-point connections.

A new capability that may be implemented for example using the Bluetooth LE protocol has been disclosed in U.S. patent application Ser. No. 12/862,282, filed Aug. 24, 2010, entitled “Advertisement of an Existing Wireless Connection”, by Mika Kasslin and Miika Laaksonen, which is incorporated herein by reference. An apparatus is enabled to advertise its existing connection with another device so that the other devices can synchronize to the existing connection and listen to the information exchanged between the apparatus and the other device, in a listen-only mode. However, the technique requires a master/slave connection to have already been established, after which other devices can join the connection in receive only mode as listeners. What would be desirable is to have the capability for a single device to operate as a transmitting node on a data channel without having to first establish a master/slave connection with a second device.

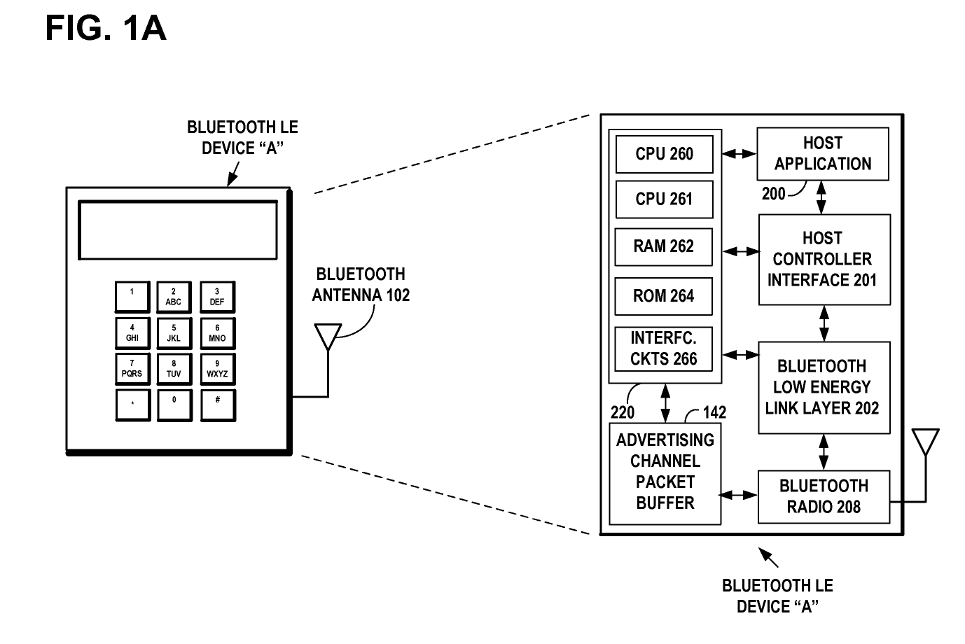

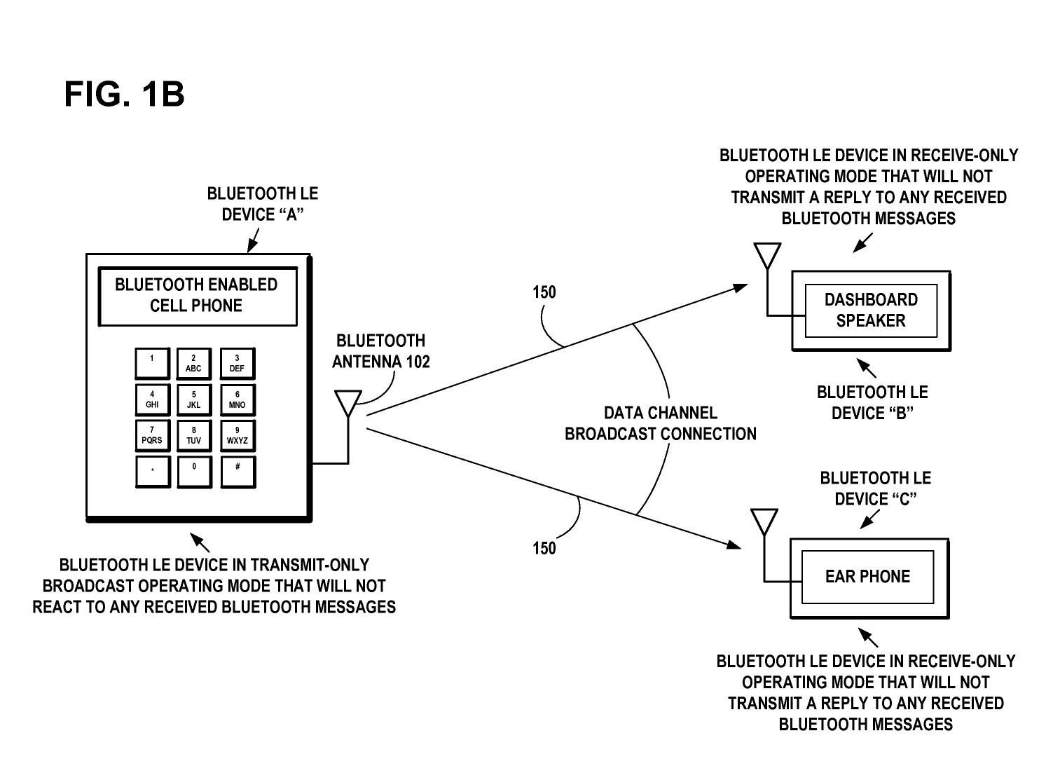

FIG. 1A is an example embodiment of a wireless device “A” using the Bluetooth LE protocol, for example a cellular telephone that is Bluetooth enabled and communicates via the Bluetooth antenna 102. The wireless device “A” may be a Bluetooth enabled communications device, PDA, cell phone, laptop or palmtop computer, or the like or it may be a Bluetooth enabled stationary access point, automotive dashboard interface, home electronics interface or other Bluetooth enabled stationary interface or device. The wireless device “A” may be a Bluetooth enabled remote controller, healthcare monitor, sports sensor, token, key fob, watch, wireless keyboard, gaming pad, body sensor, toy, health care equipment, human interface device, entertainment device, wireless microphone, GPS sensor, or the like.

In an example embodiment of the invention in FIG. 1A, the wireless device “A” may include a processor 220 that includes a dual core central processing unit (CPU) 260 and 261, a random access memory (RAM) 262, a read only memory (ROM) 264, and interface circuits 266 to interface with the radio transceiver 208. The wireless device “A” may further include a battery, solar cell, or other power sources, key pad, touch screen, display, microphone, speakers, ear pieces, camera or other imaging devices, etc. The RAM 262 and ROM 264 may be removable memory devices such as smart cards, SIMs, WIMs, semiconductor memories such as RAM, ROM, PROMS, flash memory devices, etc. according to an embodiment of the present invention. The advertising channel packet buffer 142 buffers advertising channel packets 140 to be transmitted when the device is in the Advertising State and buffers received advertising channel packets from other Bluetooth LE devices when the device is in the Scanning State.

In an example embodiment of the invention in FIG. 1A, the wireless device “A” includes the Bluetooth Low Energy protocol stack that includes Host Controller Interface (HCI) 201, Bluetooth LE Link Layer (LL) 202, and Bluetooth radio 208, which are described in the Bluetooth Core Specification, Version 4.0 protocol specification. The Host Controller Interface (HCI) 201 provides a command interface between the host application 200 and the Link Layer 202, provides access to hardware status and control registers of the Bluetooth radio 208, and provides a uniform method of accessing the Bluetooth baseband capabilities.

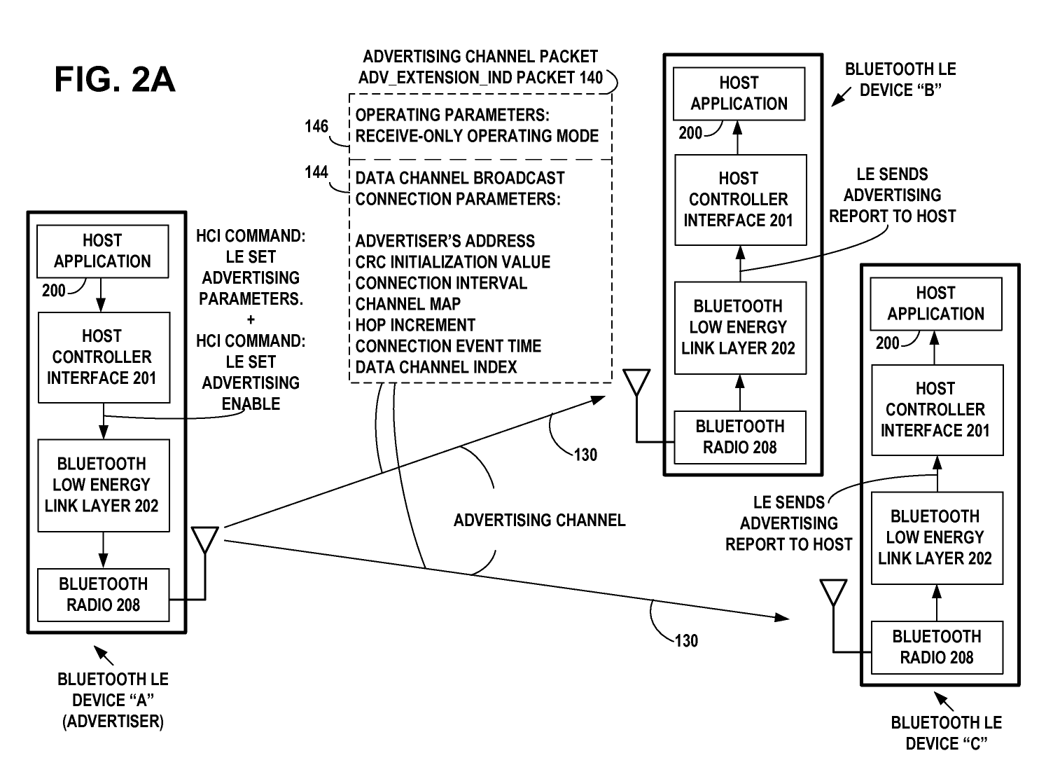

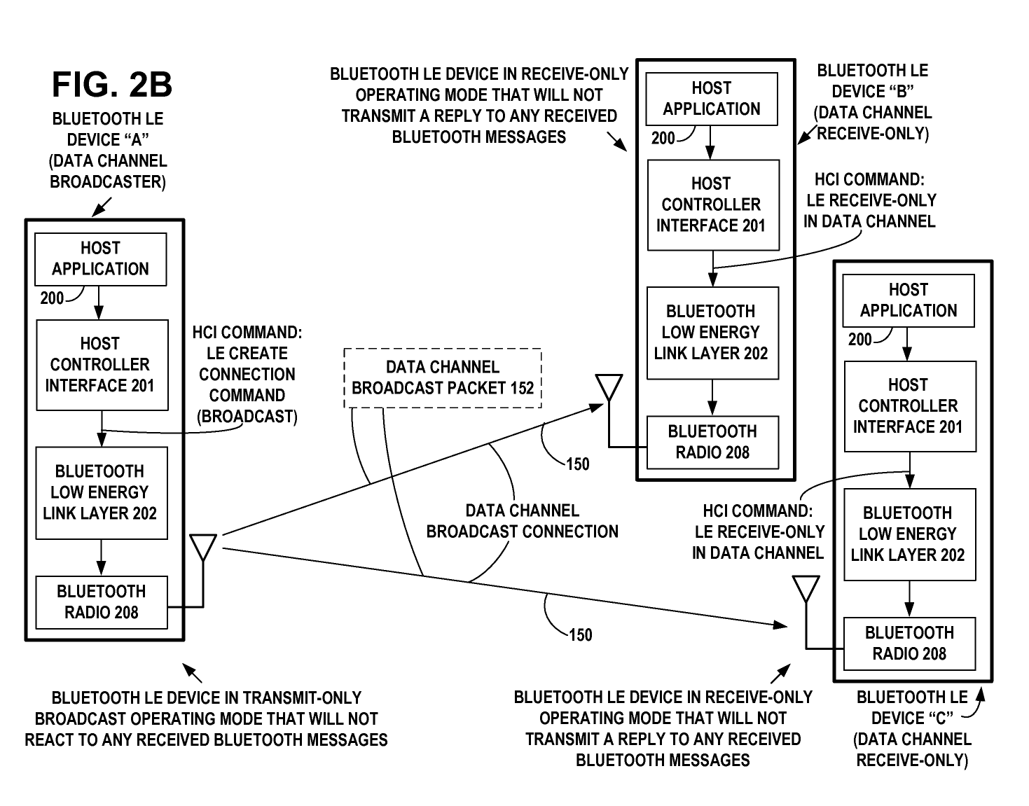

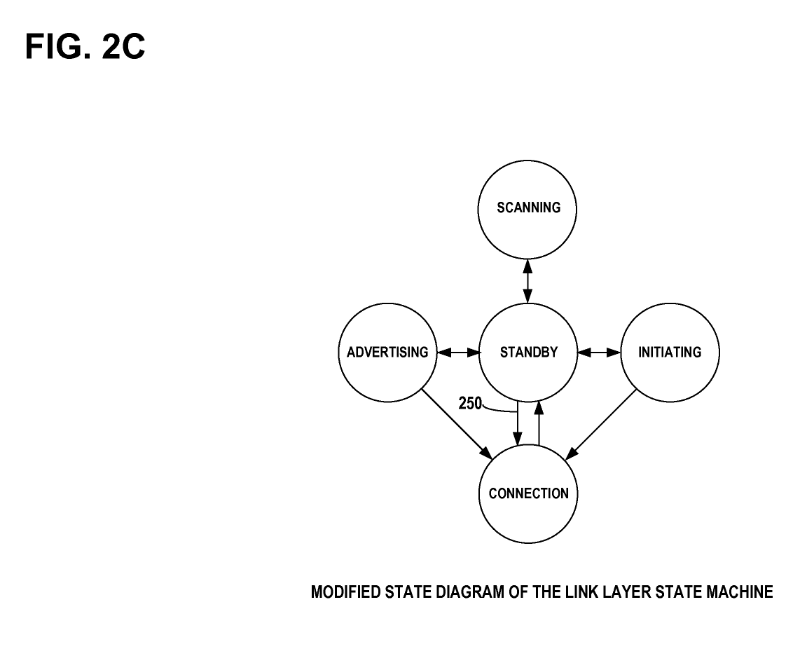

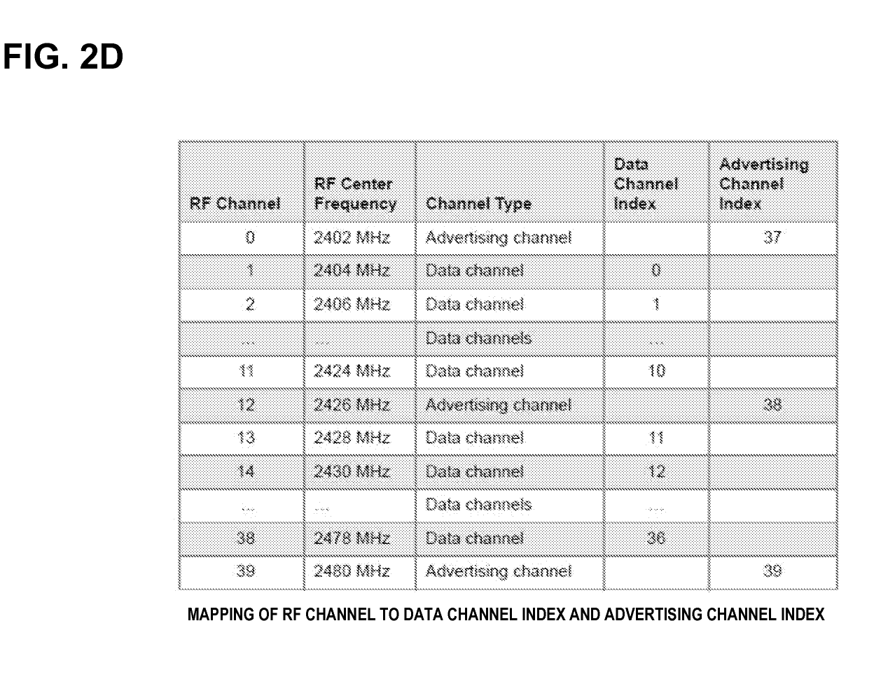

The Link Layer 202 provides a state machine with the following five states: Standby State, Advertising State, Scanning State, Initiating State, and Connection State, as shown in FIG. 2C. The Link Layer state machine allows only one state to be active at a time. The Link Layer in the Standby State does not transmit or receive any packets and can be entered from any other state. The Link Layer in the Advertising State will be transmitting advertising channel packets and possibly listening to and responding to responses triggered by these advertising channel packets. A device in the Advertising State is known as an advertiser. The Advertising State can be entered from the Standby State. The Link Layer in the Scanning State will be listening for advertising channel packets from devices that are advertising. A device in the Scanning State is known as a scanner. The Scanning State can be entered from the Standby State. The Link Layer in the Initiating State will be listening for advertising channel packets from a specific device and responding to these packets to initiate a connection with that specific device. A device in the Initiating State is known as an initiator. The Initiating State can be entered from the Standby State.

In an example embodiment of the invention, the Connection State of the Link Layer 202 may be entered either from the Standby State, the Initiating State, or the Advertising State. A device in the Connection State is known as being in a connection over a data channel. Within the Connection State, two roles are defined: the Master Role and the Slave Role. When a device directly transitions from the Standby State to the Connection State, it is in the Master Role without there being a connected slave device, it broadcasts data packets in a data channel, and it defines the timings of transmissions. When a device in the Initiating State, enters the Connection State, it is in the Master Role, it exchanges data packets with a slave device in a data channel, and it defines the timings of transmissions. When a device in the Advertising State, enters the Connection State, it is in the Slave Role and exchanges data packets with a master device in a data channel, wherein the master device defines the timings of transmissions.

In an example embodiment of the invention in FIG. 1A, the Bluetooth radio 208 operates in the unlicensed 2.4 GHz ISM band, in the same manner as does the Basic Rate/Enhanced Data Rate (BR/EDR) radio. Bluetooth LE supports very short data packets, from 8 octets to a maximum of 27 octets, giving it a low duty cycle. Bluetooth LE employs a frequency hopping transceiver with many Frequency Hopping Spread Spectrum (FHSS) carriers, with a bit rate of 1 Megabit per second (Mb/s).

Bluetooth LE employs two multiple access schemes: Frequency division multiple access (FDMA) and time division multiple access (TDMA). Forty (40) physical channels, separated by 2 MHz, are used in the FDMA scheme. Three (3) are used as advertising channels and 37 are used as data channels. A TDMA based polling scheme is used in which one device transmits a packet at a predetermined time and a corresponding device responds with a packet after a predetermined interval.

The physical channel is sub-divided into time units known as events. Data is transmitted between Bluetooth LE devices in packets that are positioned in these events. There are two types of events: Advertising and Connection events.

Devices that transmit advertising packets on the advertising Physical Layer (PHY) channels are referred to as advertisers. Devices that receive advertising on the advertising channels without the intention to connect to the advertising device are referred to as scanners. Devices that need to form a connection to another device by listening for connectable advertising packets are referred to as initiators. Transmissions on the advertising PHY channels occur in advertising events. Transmissions on the data PHY channels occur in connection events.

In an example embodiment of the invention, the wireless device “A” may also include a Bluetooth BR/EDR protocol stack (not shown), which is described in the Bluetooth Specification version 3.0+HS.

In an example embodiment of the invention in FIG. 1A, the processor 220, Host Controller Interface (HCI) 201, Bluetooth LE Link Layer (LL) 202, and/or host application program 200 may be embodied as program logic stored in the RAM 262 and/or ROM 264 in the form of sequences of programmed instructions which, when executed in the CPUs 260 and/or 261, carry out the functions of the disclosed embodiments. The program logic may be delivered to the writeable RAM, PROMS, flash memory devices, etc. 262 of the wireless device “A” from a computer program product or article of manufacture in the form of computer-usable media such as resident memory devices, smart cards or other removable memory devices. Alternately, they may be embodied as integrated circuit logic in the form of programmed logic arrays or custom designed application specific integrated circuits (ASIC). The Bluetooth radio 208 in the wireless device “A” may be separate transceiver circuits or alternately, the radio 208 may be a single radio module capable of handling one or multiple channels in a high speed, time and frequency multiplexed manner in response to the processor 220. The program code for instructing the apparatus to perform its various operations may be stored in computer readable non-transitory media, for example magnetic disks, optical storage devices, random access memories (RAMs), read-only memories (ROMs), programmable read only memories (PROMs), CD ROMS, or flash memory devices. The program code may be downloaded from such computer readable media to be stored for example in the RAM 262 or programmable ROM 264 of the wireless device “A” for execution of the program code for example by the CPUs 260 and/or 261.

In an example embodiment of the invention, the Bluetooth enabled wireless device “A” may include any of a variety of wireless personal area, wireless local area, or wireless wide area radio devices. For example the Bluetooth enabled wireless device “A” may include a Land Mobile Radio, Professional Mobile Radio, DECT (Digital Enhanced Cordless Telecommunications), 1G, 2G, 3G, 4G Cellular systems, IrDA, RFID (Radio Frequency Identification), Wireless USB, DSRC (Dedicated Short Range Communications), Near Field Communication, wireless sensor networks, ZigBee, EnOcean; Bluetooth, TransferJet, Ultra-wideband (UWB from WiMedia Alliance), WLAN, IEEE 802.11, WiFi, HiperLAN, Wireless Metropolitan Area Networks (WMAN) and Broadband Fixed Access (BWA) (LMDS, WiMAX, AIDAAS and HiperMAN), or the like.

Example non-limiting use cases for Bluetooth LE technology include wireless telephony, sports and fitness, security and proximity and smart energy. Bluetooth LE technology is designed for devices to have a battery life of up to one year such as those powered by coin-cell batteries. These types of devices include watches that will utilize Bluetooth LE technology to display Caller ID information and sports sensors that will be utilized to monitor the wearer's heart rate during exercise. The Medical Devices Working Group of the Bluetooth SIG is also creating a medical devices profile and associated protocols to enable Bluetooth applications for Bluetooth LE devices.

FIG. 1B is an example data channel broadcast connection use case for the Bluetooth LE protocol device of FIG. 1B, according to at least one embodiment. In this example, the wireless device “A” is a Bluetooth enabled cellular telephone that uses the Bluetooth LE protocol to broadcast digital voice signals via the Bluetooth antenna 102 to a Bluetooth enabled automobile dashboard speaker “B” and a Bluetooth enabled ear phone “C”, both of which use the Bluetooth LE protocol. The Bluetooth enabled cellular telephone “A” creates operating parameters for a data channel broadcast connection 150 to form a transmit-only operating mode at the broadcast transmitting device “A”. Non-limiting examples of operating parameters for a data channel broadcast connection 150, that may be applied to transmitting operations of the Bluetooth enabled cellular telephone “A”, include example operating parameters for a transmit-only mode that blocks any incoming messages from the data channel receiver, i.e., the dashboard speaker “B” or the ear phone “C”, a transmit-only mode that accepts flow control information from the data channel receiver, a transmit-only mode with initial setup for encryption and message authentication, and the like.

In an example embodiment of the invention, the operating parameters created by the Bluetooth enabled cellular telephone “A” for the data channel broadcast connection 150 may further include operating parameters to form a receive-only operating mode at the broadcast receiving dashboard speaker “B” and ear phone “C”. Non-limiting examples of operating parameters for a data channel broadcast connection, that may be applied to receiving operations of the data channel receiver, i.e., the dashboard speaker “B” or the ear phone “C”, include example operating parameters for a receive-only mode that blocks replies to the data channel sender “A”; a receive-only mode with flow control information allowed back to the data channel sender “A”; a receive-only mode with initial setup for encryption and message authentication, a receive-only mode that blocks transmissions on all channels (but allows scanning on advertising channels 130); a receive-only mode that blocks replies to the data channel sender and prohibits scanning on any advertising channels 130, and the like.

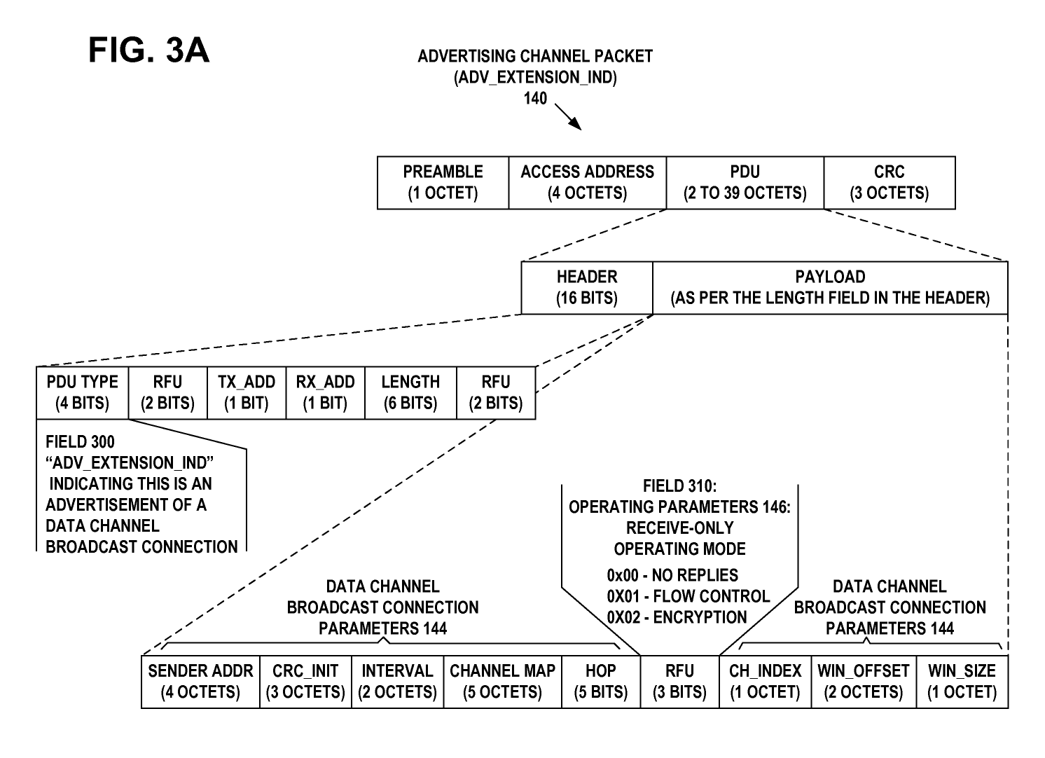

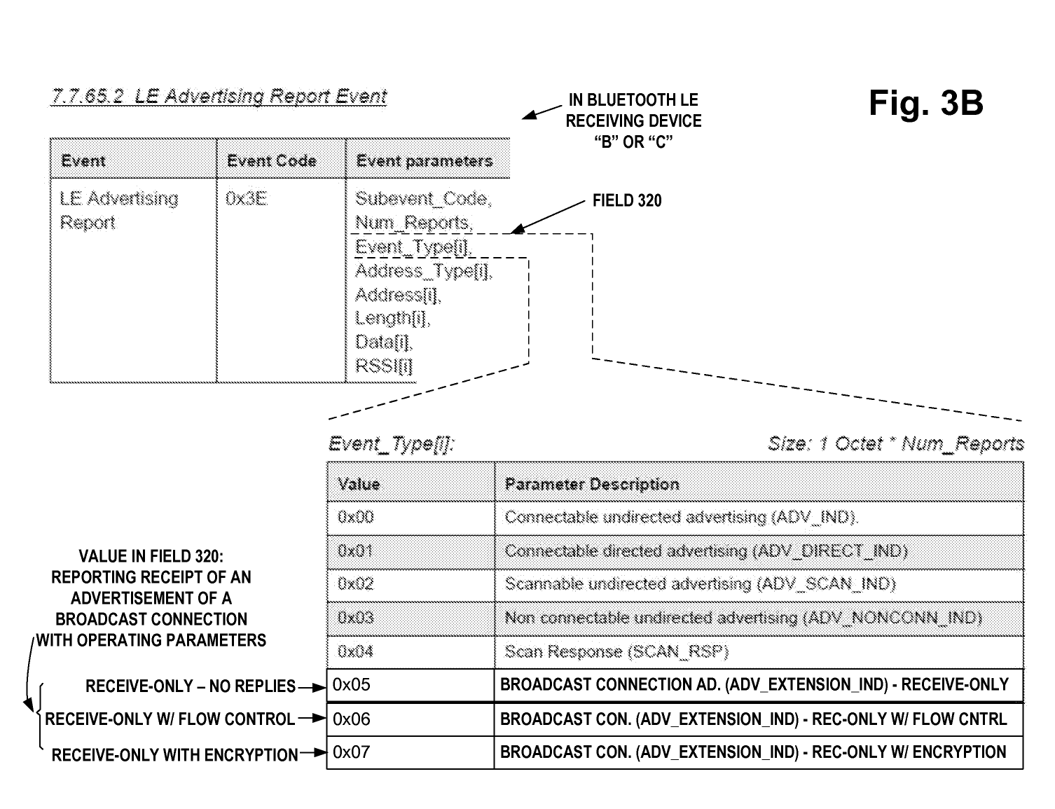

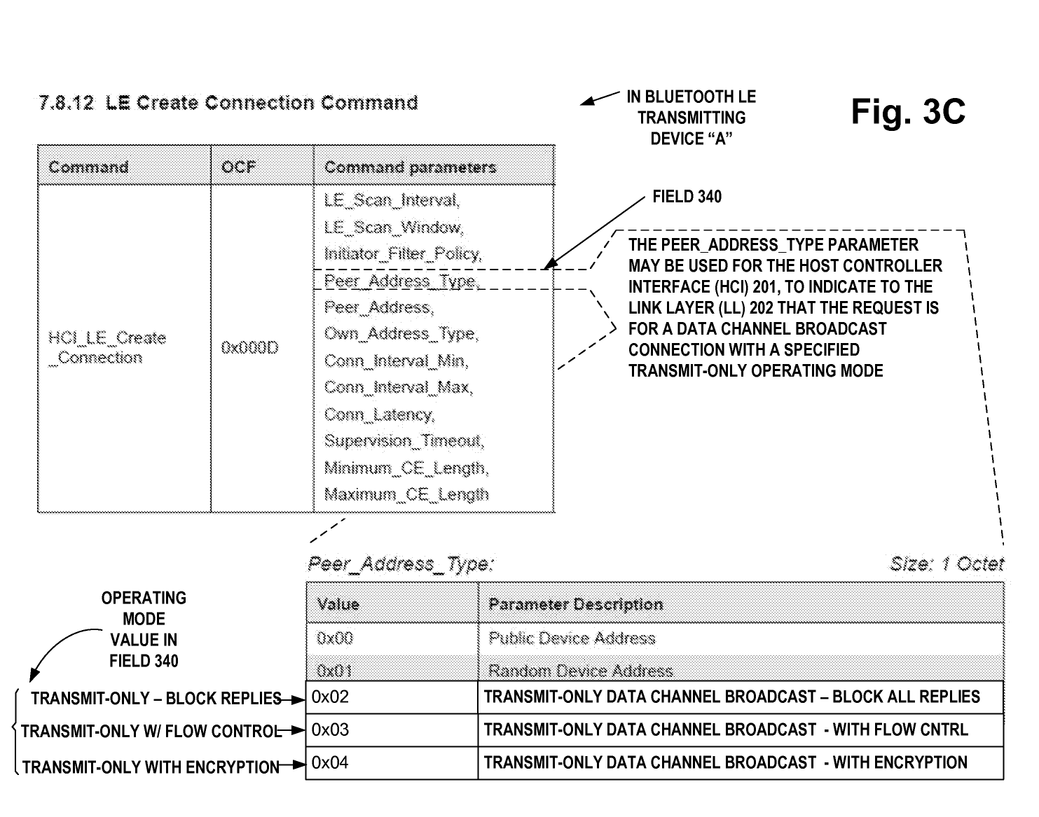

FIG. 2A is an example embodiment of a wireless network with the Bluetooth enabled wireless device “A” of FIG. 1B, transmitting on a Bluetooth Low Energy advertising channel 130 to other Bluetooth enabled wireless devices “B” and “C”, a non-connectable undirected advertising channel packet 140 with data channel broadcast connection parameters 144 and operating parameters 146 for a receive-only operating mode associated with the data channel broadcast connection 150, according to at least one embodiment. The Host Controller Interface (HCI) 201 in the Bluetooth enabled wireless device “A” issues an HCI command to the Link Layer (LL) 202: “LE Set Advertising Parameters” with the values of the data channel broadcast connection parameters 144 indicating the data channel broadcast connection 150 and the operating parameters 146 associated with the data channel broadcast connection 150, provided by the host application 200, for example. The Host Controller Interface (HCI) 201 issues an HCI command to the Link Layer (LL) 202: “LE Set Advertising Enable (enable)” to cause the link level to assemble the advertising channel packet “ADV_EXTENSION_IND” 140, as shown in FIG. 3A, in the advertising channel packet buffer 142. These two HCI commands are specified in the Bluetooth Core Specification, Version 4.0.

In an example embodiment of the invention of FIG. 2A, the host application 200 of the Bluetooth enabled transmitting device “A” creates the operating parameters 146 for a data channel broadcast connection 150. Non-limiting examples of operating parameters 146 for a data channel broadcast connection 150, that may be applied to receiving operations of the data channel receiver “B” or “C”, include example operating parameters for a receive-only mode that blocks replies to the data channel sender “A”; a receive-only mode with flow control information allowed back to the data channel sender “A”; a receive-only mode with initial setup for encryption and message authentication, a receive-only mode that blocks transmissions on all channels (but allows scanning on advertising channels 130); a receive-only mode that blocks replies to the data channel sender and prohibits scanning on any advertising channels 130, and the like. The operating parameters 146 form a part of the advertising channel packet 140.

In an example embodiment of the invention of FIG. 2A, the Host Controller Interface (HCI) 201 and the Link Layer (LL) 202 form the data channel broadcast connection parameters 144 as part of the advertising channel packet 140. Examples of data channel broadcast connection parameters 144 indicating the data channel broadcast connection 150, include information related to the physical channel and timing of the connection event, such as a channel map indicating used and unused data channels, a hop increment used in data channel selection, a channel index for the advertised connection event, a start time or transmission window for the advertised connection event, and the like.

In an example embodiment of the invention of FIG. 2A, the Bluetooth enabled cellular telephone “A” then transmits on a Bluetooth Low Energy advertising channel 130, one or more non-connectable undirected advertising channel messages 140 with data channel broadcast connection parameters 144 indicating the data channel broadcast connection 150 and the operating parameters 146 associated with the data channel broadcast connection 150.

In an example embodiment of the invention, the receiving devices “B” and “C” have been in the scanning state on the three advertising channels 130, listening for advertising channel packets from devices that are advertising. Once a scanning device has received the advertising channel packet ADV_EXTENSION_IND 140 from device “A”, if it wishes to synchronize to data channel broadcast packets 152 sent from device “A”, it must determine its frequency hopping sequence on the 37 data channels to identify the data channel for the next connection event or a subsequent connection event. The receiving device “B” and/or “C” then tunes to the data channel and starts listening for the data channel broadcast packets 152 from device “A”. If the connection event start time is given as an absolute value in the advertising channel packet ADV_EXTENSION_IND 140, the event is assumed to start at the specified time. But, if a time window is given in advertising channel packet ADV_EXTENSION_IND 140, the connection event is assumed to start within the window. In general, the operations are similar to those performed by a slave device in joining a bi-directional master/slave connection, except that the receiving device “B” and/or “C” joins the data channel broadcast connection 150 as a receive-only device that does not transmit anything to the broadcasting device “A”.

In an example embodiment of the invention of FIG. 2A, the Bluetooth enabled dashboard speaker “B” and ear phone “C” receive from the transmitting device “A”, the one or more non-connectable undirected advertising channel messages 140, determine whether the one or more non-connectable undirected advertising channel messages 140 include data channel broadcast connection parameters 144 indicating a Bluetooth Low Energy data channel broadcast connection 150 and operating parameters 146 associated with the data channel broadcast connection 150.

In an example embodiment of the invention of FIG. 2A, when receiving Bluetooth LE devices “B” and “C” receive the advertising channel packet “ADV_EXTENSION_IND” 140, it is buffered in their respective advertising channel packet buffer (not shown). The Link Layer

(LL) 202 recognizes the field 300 as indicating that the received advertising packet is for broadcast connection advertising (ADV_EXTENSION_IND). The Link Layer (LL) 202 in the respective device “B” and “C” sends an advertising report to its respective Host Controller Interface (HCI) 201 and host application 200, as shown in FIG. 3B, with the event type field 320 specifying that the advertising event is data channel broadcast connection advertisement (ADV_EXTENSION_IND) that specifies operating parameters associated with the data channel broadcast connection. The advertising report of FIG. 3B also indicates the specified operating parameters for the receiving device, for example, receive-only with no replies (Field 320=0x05), receive-only with flow control (Field 320=0x06), receive-only with encryption (Field 320=0x07), and the like.

In an example embodiment of the invention, the Bluetooth enabled receiving devices dashboard speaker “B” and ear phone “C” may adopt the operating parameters 146 from the one or more received advertising messages 140 when the one or more non-connectable undirected advertising channel messages 140 include data channel broadcast connection parameters 144 indicating a Bluetooth Low Energy data channel broadcast connection 150 and operating parameters 146 associated with the data channel broadcast connection 150.

In an example embodiment of the invention, if the respective host application 200 in one or both of the receiving devices “B” and/or “C” decides to receive the data channel broadcast packets 152 in the specified data channel, the respective host application 200 in the receiving device conveys an appropriate HCI command to the respective Link Layer (LL) 202, that requires receiving the data channel broadcast packets in the specified data channel in a receive-only mode, for example “LE Receive-Only In Data Channel”, shown in FIG. 2B. An example technique to accomplish receive-only operation in the data channel broadcast connection with no replies to the sending device, is for the host application 200 or Host Controller Interface (HCI) 201 in the receiving device “B” or “C” to artificially force a flow control STOP condition on the Link Layer (LL) 202 so that no acknowledgements or other replies are returned from the receiving device “B” or “C” to the broadcasting device “A”.

The Bluetooth enabled receiving devices dashboard speaker “B” and ear phone “C” that adopt the operating parameters 146, may then receive the information on the Bluetooth Low Energy data channel broadcast connection 150 according to the operating parameters 146 associated with the data channel broadcast connection 150.

FIG. 2B is an example embodiment of the Bluetooth enabled wireless network of FIG. 2A, wherein the transmitting device “A” transmits the data channel packet 152 in the data channel that was specified in the advertising channel packet 140 and the other devices “B” and “C” receive the broadcast data channel packet 152 in a receive-only mode, according to at least one embodiment. In example embodiments of the invention, the Host Controller Interface (HCI) 201 in transmitting device “A” issues an HCI command to the Link Layer (LL) 202, “LE Create Connection Command” (HCI_LE_Create_Connection). The “LE Create Connection Command” command is modified from its specification in section 7.8.12 of the Bluetooth Core Specification, Version 4.0, where it is only used to create a Link Layer connection to a connectable advertiser. In example embodiments of the invention, the “LE Create Connection Command” command is modified to allow the host application 200 in the transmitting (and advertising) device to command the Link Layer (LL) 202 to create a data channel broadcast connection without an advertiser device. The modified “LE Create Connection Command” includes a parameter field 340, shown in FIG. 3C, to indicate whether the command is to create a normal master/slave connection as in the existing specification or to create a connection that has only one device that operates in the data channel broadcast connection mode. In example embodiments of the invention, the Peer_Address_Type parameter of the “LE Create Connection Command” command may be used to indicate the connection type in the parameter 340, as shown in FIG. 3C. In the existing Bluetooth Core Specification, Version 4.0, the Peer_Address_Type parameter is used to indicate the advertiser's address type. However, in the modified “LE Create Connection Command” for the broadcast type connection, there is no advertiser and, thus, one of the reserved values (for example, 0x02) of the Peer_Address_Type parameter may be used in the parameter field 340 for the Host Controller Interface (HCI) 201, to indicate to the Link Layer (LL) 202 that the request is for a data channel broadcast connection, as shown in FIG. 3C. Non-limiting examples of operating parameters 146 for a data channel broadcast connection 150, that may be applied to transmitting operations of the device “A”, include example operating parameters for a transmit-only mode that blocks any incoming messages from the data channel receiver “B” or “C” (Field 340=0x02), a transmit-only mode that accepts flow control information from the data channel receiver (Field 340=0x03), a transmit-only mode with initial setup for encryption and message authentication (Field 340=0x04), and the like.

Bluetooth enabled cellular telephone “A” then transmits in the broadcast operating mode, information, such as a digital voice data packet 152, on the Bluetooth Low Energy data channel broadcast connection 150 to the Bluetooth enabled dashboard speaker “B” and the ear phone “C”, according to the transmit-only operating mode operating parameters 146 associated with the data channel broadcast connection 150.

FIG. 2C is a state diagram of the Link Layer (LL) that is modified to add the state transition 250 to allow the Link Layer 202 to transition directly from the Standby State to the Connection State, according to at least one embodiment. When a device directly transitions via the state transition 250 from the Standby State to the Connection State, it assumes the Master Role without there being a connected slave device, it broadcasts data packets in a data channel broadcast connection, and it defines the timings of transmissions.

In an example embodiment of the invention, certain changes may be made to the Link Layer specification in the existing Bluetooth Core Specification, Version 4.0. The Link Layer (LL) state diagram of FIG. 2C may be modified to allow a direct transition from the Standby State to the Connection State, in order to enable the broadcast transmitting device “A” to directly respond to the “LE Create Connection Command” issued by its Host Controller Interface (HCI) 201. As shown in FIG. 2C, the specification has been modified to allow a direct state transition from the Standby State to the Connection State.

In an example embodiment of the invention, another change may be made to the Link Layer specification in the existing Bluetooth Core Specification, Version 4.0, wherein the definitions of the Connection State may be modified to state that the Link Layer enters the Connection State directly from the Standby State when directed by the Host, to create a connection in broadcast mode. In this case, the Link Layer does not transmit any connection request packet in an advertising channel, but the Link Layer transitions directly to the Connection State. The connection is considered to be both created and established after entering the Connection State. The Link Layer in the transmitting device is considered to be the master and there is be no slave device in the connection.

In an example embodiment of the invention, another change may be made to the Link Layer specification in the existing Bluetooth Core Specification, Version 4.0, wherein the connection events will be Data Channel PDU transmissions only from the master. The master may determine when the connection event closes. The master may transmit any number of PDUs in an event, as long as it closes the event before the next event is scheduled to start, as per the connection parameters. Subsequent PDUs within an interval may be separated by T_IFS in time (i.e. the time from the end of a PDU to the beginning of the next PDU is T_IFS; T_IFS is the interframe space).

In an example embodiment of the invention, another change may be made to the Link Layer specification in the existing Bluetooth Core Specification, Version 4.0, wherein the connection has no supervision timeout and it may remain established and active until the master terminates it. The transmitting device may stop running the connection without any notification to the receiving devices that have joined the connection in receive-only mode. The master may, however, use the connection termination PDU (LL_TERMINATE_IND) to indicate the termination to the receiving devices. The connection parameters may remain the same for the entire lifetime of the connection.

In an example embodiment of the invention, additional changes may be made to the existing Bluetooth Core Specification, Version 4.0, in the following sections of the specification:

Changes to the Generic Access Profile:

In an example embodiment of the invention, the Connection Broadcast mode may be a new operation mode for the Bluetooth Low Energy protocol described in the existing Generic Access Profile (Part C, Volume 3) of the Bluetooth Core Specification, Version 4.0. The new Connection Broadcast mode may be specified in the following manner:

Section 9.5 Connection Broadcast Mode:

The connection broadcast mode allows a device to transmit data to any number of devices that operate in receive only mode in a connection. The device that operates in the connection broadcast mode uses the connection scheme and the connection events to communicate data in unidirectional connectionless manner. A device that operates in the connection broadcast mode is called Connection broadcaster.

Section 9.5.1 Definition:

The connection broadcast mode provides a method for a device to send connectionless data using the connection scheme to multiple devices that operate in receive-only mode.

Section 9.5.2 Conditions:

A device in the connection broadcast mode shall send data in connection events of the connection it has established. The device establishes a connection without any connection creation phase with an advertising device. The device determines the connection parameters and starts scheduling connection events as the master of the connection. The device shall send data in the connection as if in normal connection. The device shall advertize the connection in non-connectable undirected advertizing events using the ADV_EXTENSION_IND packets.

Changes to the HCI Specification:

The HCI specification of the Bluetooth Core Specification, Version 4.0 specifies all the LE Controller commands in section 7.8. The command “LE Create Connection Command” (HCI_LE_Create_Connection) specified in section 7.8.12 is used to create a Link Layer connection to a connectable advertiser. In an example embodiment of the invention, the definition of that command is modified to allow the Host to command the Link Layer to create a connection without an advertiser. To indicate whether the request is for a normal connection with a master and a slave or for a unidirectional connection that has only one device that operates in the connection broadcast mode. The Peer_Address_Type parameter of the command may be used to indicate the connection type, since there is no advertiser.

FIG. 2D is a mapping of RF channels to Bluetooth Low Energy data channels and Bluetooth Low Energy advertising channels, according to at least one embodiment. Bluetooth LE communicates over a total of 40 RF channels, each having a bandwidth of 2 MHz. Data communication between Bluetooth LE devices occurs in 37 pre-specified data channels, of the 40 RF channels. All data connection transmissions occur in connection events. The remaining 3 channels, of the 40 RF channels, are advertising channels used by devices to advertise their existence and capabilities.

FIG. 3A is an example packet structure of advertising channel packet ADV_EXTENSION_IND 140, according to at least one embodiment. The Bluetooth LE Link Layer has only one packet format used for both advertising channel packets and data channel packets. Each packet consists of four fields: the preamble, the Access Address, the protocol data unit (PDU), and the cyclic redundancy code (CRC). The preamble is 1 octet and the Access Address is 4 octets. The PDU range is from 2 to a maximum of 39 octets. The CRC is 3 octets. The Access Address for all advertising channel packets is hex value 0x8E89BED6.

In an example embodiment of the invention, the preamble and Access Address are followed by a PDU. The advertising channel PDU has a 16-bit header and a variable size payload. The PDU Type field of the advertising channel PDU that is contained in the header indicates the PDU type. In an example embodiment of the invention, the PDU type field 300 that is contained in the header of the advertising channel packet ADV_EXTENSION_IND 140 indicates that this packet is an advertisement of a data channel broadcast connection on the data channel specified in the packet.

In an example embodiment of the invention, the TxAdd and RxAdd fields of the advertising channel PDU that are contained in the header, contain information specific to the PDU type defined for each advertising channel PDU. The Length field of the advertising channel PDU header indicates the payload field length in octets, and may be 6 to 37 octets.

In an example embodiment of the invention, the Payload fields in the advertising channel PDUs are specific to the PDU Type. For the advertising channel packet ADV_EXTENSION_IND 140, the example payload field may include the following fields. The data channel broadcast connection parameters 144 include:

SenderAddress=Contains the sender's access address.

CRCInit=Contains the initialization value for the CRC calculation.

Interval=Contains connInterval parameter value.

ChannelMap=Contains the channel map indicating Used and Unused data channels. Every channel is represented with a bit positioned as per the data channel index.

Hop=Indicates the hopIncrement used in the data channel selection algorithm, and has a random value in the range of 5 to 16.

ChIndex=Indicates unmapped data channel index for the connection event advertised.

WinOffset=Indicates start time of the connection event start transmission window.

WinSize=Indicates connection event start transmission window size.

In an example embodiment of the invention, the RFU field is Field 310 that specifies the Operating parameters 146 for the data channel broadcast connection 150. In the example shown, the parameter in field 310 specifies a Receive-only operating mode. Non-limiting examples of operating parameters 146 for a data channel broadcast connection 150, that may be applied to receiving operations of the data channel receiver “B” or “C”, include example operating parameters for a receive-only mode that blocks replies to the data channel sender “A” (Field 310=0x00); a receive-only mode with flow control information allowed back to the data channel sender “A” (Field 310=0x01); a receive-only mode with initial setup for encryption and message authentication (Field 310=0x02), a receive-only mode that blocks transmissions on all channels (but allows scanning on advertising channels 130) (Field 310=0x03); a receive-only mode that blocks replies to the data channel sender and prohibits scanning on any advertising channels 130 (Field 310=0x04), and the like.

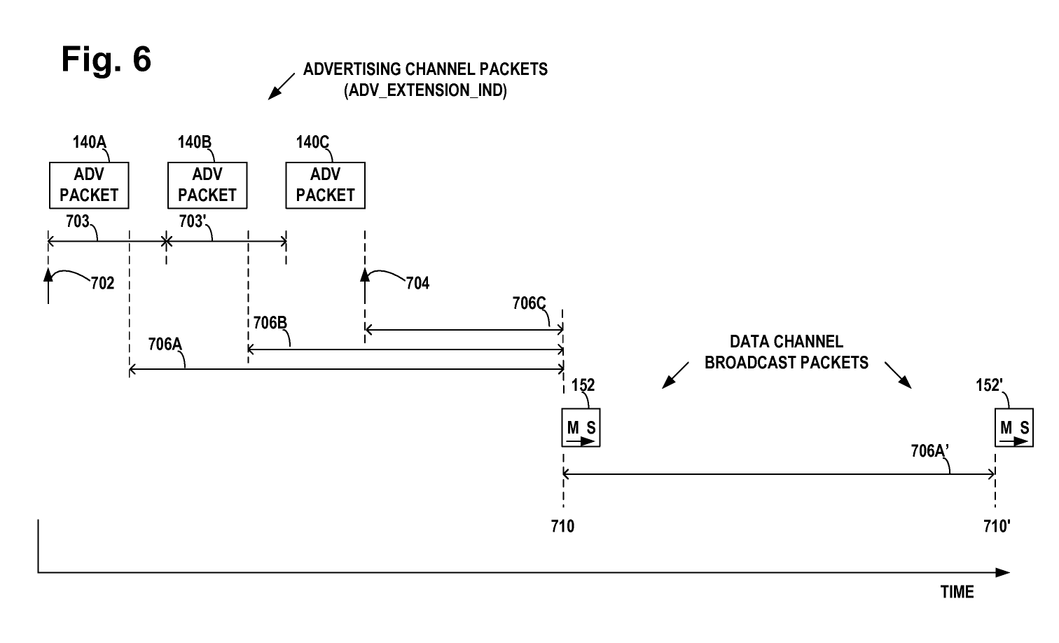

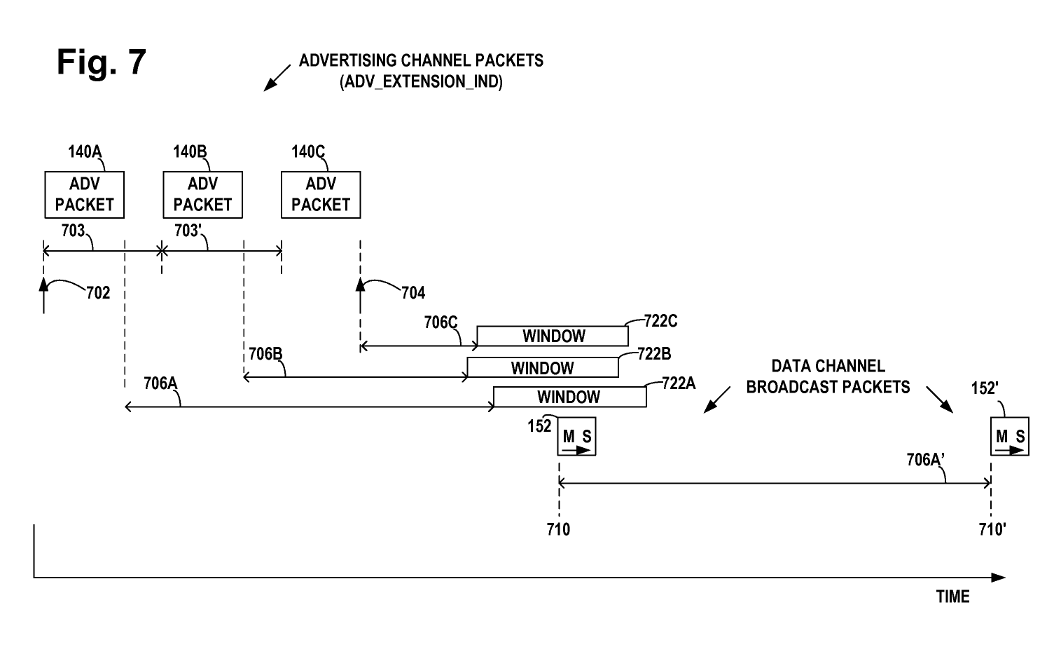

In an example embodiment of the invention, the parameter WinOffset (Connection event time) indicates start time of the next or a subsequent connection event. Alternatively it may indicate start time of one of the following connection events. It necessarily doesn't have to be the next event but any of the connection events whose time and frequency parameters are known. It may be indicated as an absolute value that indicates time from the advertising channel packet/PDU to the beginning of the next or a subsequent connection event, as shown in FIG. 6. Alternatively a time span WinSize may be given to indicate a time window during which the next or a subsequent connection event will start, as shown in FIG. 7.

In an example embodiment of the invention, the parameter ChIndex (Data channel index) indicates the unmapped channel index of the connection event whose start time is indicated with the WinOffset parameter.

Additionally there may be other parameters in the example advertising channel packet ADV_EXTENSION_IND 140 that are considered useful. The advertising channel packet ADV_EXTENSION_IND 140 may also include, for example, advertising data describing the advertiser's host.

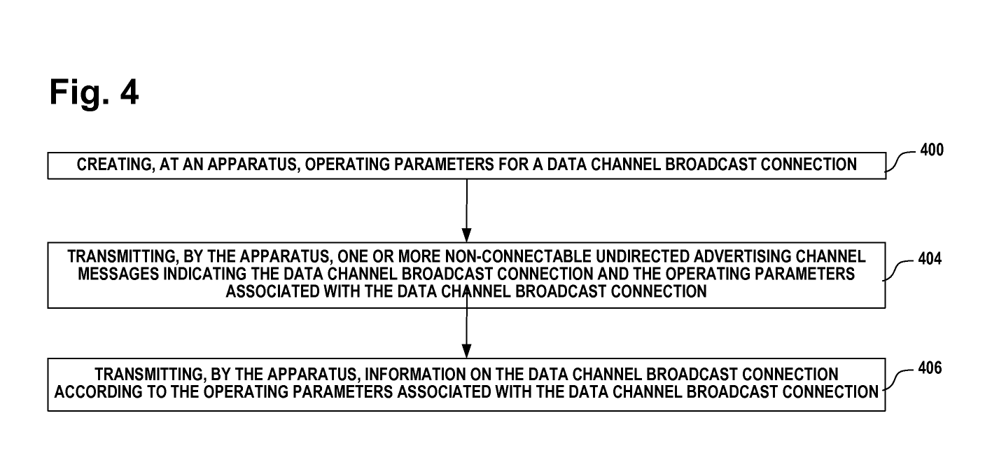

FIG. 4 is an example embodiment of a flow diagram of a method, from the point of view of the advertiser device “A”, using the Bluetooth Low Energy protocol, according to at least one embodiment. The steps of the flow diagram represent computer code instructions stored in the RAM and/or ROM memory of the advertiser device “A”, which when executed by the central processing units (CPU) CPU1 and/or CPU2, carry out the functions of the example embodiments of the invention. The steps may be carried out in another order than shown and individual steps may be combined or separated into component steps. The flow diagram has the following steps:

Step 400: creating, at an apparatus, operating parameters for a data channel broadcast connection;

Step 402: transmitting, by the apparatus, one or more non-connectable undirected advertising channel messages indicating the data channel broadcast connection and the operating parameters associated with the data channel broadcast connection; and

Step 404: transmitting, by the apparatus, information on the data channel broadcast connection according to the operating parameters associated with the data channel broadcast connection.

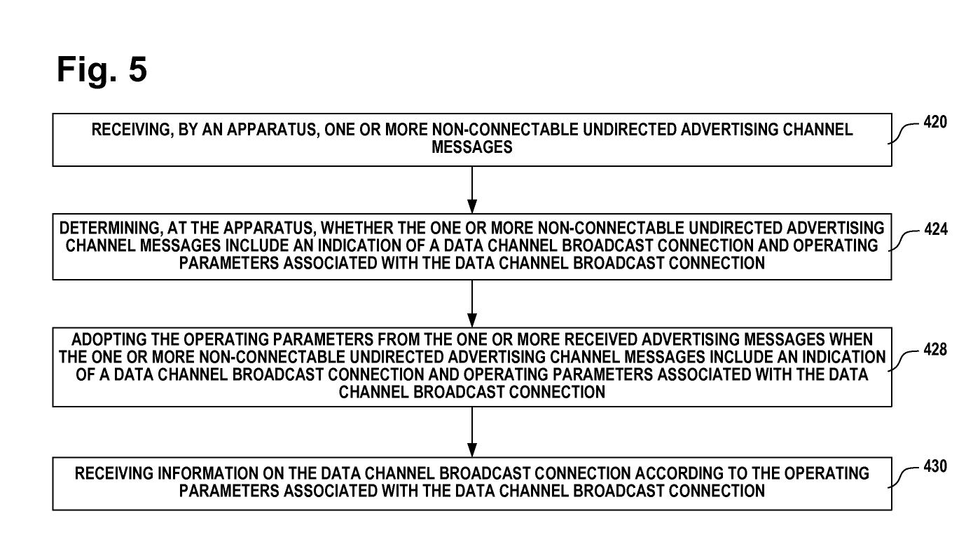

FIG. 5 is an example embodiment of a flow diagram of a method, from the point of view of the receiving device “B” or “C”, using the Bluetooth Low Energy protocol according to at least one embodiment. The steps of the flow diagram represent computer code instructions stored in the RAM and/or ROM memory of the receiving device “B” or “C”, which when executed by the central processing units (CPU) CPU1 and/or CPU2, carry out the functions of the example embodiments of the invention. The steps may be carried out in another order than shown and individual steps may be combined or separated into component steps. The flow diagram has the following steps:

Step 420: receiving, by an apparatus, one or more non-connectable undirected advertising channel messages;

Step 424: determining, at the apparatus, whether the one or more non-connectable undirected advertising channel messages include an indication of a data channel broadcast connection and operating parameters associated with the data channel broadcast connection;

Step 428 adopting the operating parameters from the one or more received advertising messages when the one or more non-connectable undirected advertising channel messages include an indication of a data channel broadcast connection and operating parameters associated with the data channel broadcast connection; and

Step 430: receiving information on the data channel broadcast connection according to the operating parameters associated with the data channel broadcast connection.

In an example embodiment of the invention, the receiving device “B” or “C” scans for advertising channel packets ADV_EXTENSION_IND 140. The receiving device “B” or “C” may scan for the advertiser's address, either the advertiser's public or random device address in the advertising channel packet ADV_EXTENSION_IND 140. The device “B” or “C” may scan for specific advertising data describing the advertiser's host in the advertising channel packet ADV_EXTENSION_IND 140, for example.

In an example embodiment of the invention, the receiving device “B” or “C” receives an advertising channel packet ADV_EXTENSION_IND 140 and determines the data channel for one of the next connection events from the Data channel index parameter Chlndex, the Channel map parameter ChannelMap, and the Hop increment parameter Hop. The receiving device “B” or “C” then tunes to the data channel and starts listening for the packets in the connection. If the event start time is given as an absolute value in the advertising channel packet ADV_EXTENSION_IND 140, the event is assumed to start at the specified time. But, if a time window is given in advertising channel packet ADV_EXTENSION_IND 140, the event is assumed to start within the window.

FIG. 6 is an example embodiment of a timing diagram for the advertiser device “A” advertising of a broadcast connection when the connection event time 706A is indicated with a time offset parameter WinOffset from the occurrence of the end of the advertising channel packet ADV_EXTENSION_IND 140. Three consecutive advertising channel packets ADV_EXTENSION_IND 140A, 140B, and 140C are transmitted, starting at the beginning 702 of the advertising event and transmitted by the device 110 at maximum 10ms intervals 703 and 703′ until the end 704 of the advertising event. Each advertising channel packet ADV_EXTENSION_IND 140 includes a value for the parameter WinOffset, the connection event time, which indicates the start time of the next connection event 710 when the device “A” transmits a data channel broadcast connection packet 152, as indicated at 710. The consecutive advertising channel packets ADV_EXTENSION_IND 140A, 140B, and 140C respectively include a time offset parameter WinOffset with a duration 706A, 706B, and 706C. The consecutive advertising channel packets ADV_EXTENSION_IND 140A, 140B, and 140C respectively include the data channel index parameter Chlndex that indicates the unmapped channel index 708 of the next connection event 710. The second next connection event time 706A′ for the start of the second next connection event 710′ for a second data channel broadcast connection packet 152′, is shown in the FIG. 6, which corresponds to the connection interval parameter Interval in the advertising channel packet ADV_EXTENSION_IND.

FIG. 7 is an example embodiment of a timing diagram for advertising of a broadcast connection when the connection event start time is indicated in the advertising channel packet ADV_EXTENSION_IND as an event start time window WinSize 722A, 722B, and 722C and window offset WinOffset 720A, 720B, and 720C in the respective advertising channel packets ADV_EXTENSION_IND 140A, 140B, and 140C.

In an example embodiment of the invention, an apparatus comprises:

means for creating, at an apparatus, operating parameters for a data channel broadcast connection;

means for transmitting, by the apparatus, one or more non-connectable undirected advertising channel messages indicating the data channel broadcast connection and the operating parameters associated with the data channel broadcast connection; and

means for transmitting, by the apparatus, information on the data channel broadcast connection according to the operating parameters associated with the data channel broadcast connection.

In an example embodiment of the invention, an apparatus comprises:

means for receiving, by an apparatus, one or more non-connectable undirected advertising channel messages;

means for determining, at the apparatus, whether the one or more non-connectable undirected advertising channel messages include an indication of a data channel broadcast connection and operating parameters associated with the data channel broadcast connection;

means for adopting the operating parameters from the one or more received advertising messages when the one or more non-connectable undirected advertising channel messages include an indication of a data channel broadcast connection and operating parameters associated with the data channel broadcast connection; and

means for receiving information on the data channel broadcast connection according to the operating parameters associated with the data channel broadcast connection.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable medium or in any transmitting medium which transmits such a program.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments have been disclosed, a person skilled in the art will understand that changes can be made to the specific example embodiments without departing from the spirit and scope of the invention.

What is claimed is:

1. A method, comprising:
creating, at an apparatus, operating parameters for a data channel broadcast connection;
transmitting, by the apparatus, one or more non-connectable undirected advertising channel messages indicating the data channel broadcast connection and the operating parameters associated with the data channel broadcast connection; and
transmitting, by the apparatus, information on the data channel broadcast connection according to the operating parameters associated with the data channel broadcast connection.

2. The method of claim 1, wherein the apparatus is in transmit-only mode while transmitting the information on the data channel broadcast connection.

3. The method of claim 1, wherein the apparatus blocks any incoming messages while transmitting the information on the data channel broadcast connection.

4. The method of claim 1, wherein the advertising channel message is transmitted on a Bluetooth Low Energy advertising channel and the data channel message is broadcast on a Bluetooth Low Energy data channel.

5. The method of claim 1, wherein the operating parameters included in the advertising channel messages enable a receiving device to receive the information transmitted on the data channel broadcast connection.

6. A method, comprising:
receiving, by an apparatus, one or more non-connectable undirected advertising channel messages;
determining, at the apparatus, whether the one or more non-connectable undirected advertising channel messages include an indication of a data channel broadcast connection and operating parameters associated with the data channel broadcast connection;
adopting the operating parameters from the one or more received advertising messages when the one or more non-connectable undirected advertising channel messages include an indication of a data channel broadcast connection and operating parameters associated with the data channel broadcast connection; and
receiving information on the data channel broadcast connection according to the operating parameters associated with the data channel broadcast connection.

7. The method of claim 6, wherein the apparatus is in receive-only mode while receiving the information on the data channel broadcast connection.

8. The method of claim 6, wherein the advertising channel message is received on a Bluetooth Low Energy advertising channel and the information is received on a Bluetooth Low Energy data channel.

9. The method of claim 6, wherein the operating parameters associated with the data channel broadcast connection included in the one or more advertising channel messages enable the apparatus to receive the information on the data channel broadcast connection.

10. The method of claim 6, wherein the operating parameters included in the advertising channel messages enable the apparatus to synchronize to the data channel broadcast connection to receive the information on the data channel broadcast connection.

11. An apparatus, comprising:
at least one processor;
at least one memory including computer program code;
the at least one memory and the computer program code configured to, with the at least one processor, cause the apparatus at least to:
create, at an apparatus, operating parameters for a data channel broadcast connection;
transmit, by the apparatus, one or more non-connectable undirected advertising channel messages indicating the data channel broadcast connection and the operating parameters associated with the data channel broadcast connection; and
transmit, by the apparatus, information on the data channel broadcast connection according to the operating parameters associated with the data channel broadcast connection.

12. The apparatus of claim 11, wherein the apparatus is in transmit-only mode while transmitting the information on the data channel broadcast connection.

13. The apparatus of claim 11, wherein the apparatus blocks any incoming messages while transmitting the information on the data channel broadcast connection.

14. The apparatus of claim 11, wherein the advertising channel message is transmitted on a Bluetooth Low Energy advertising channel and the data channel message is broadcast on a Bluetooth Low Energy data channel.

15. The apparatus of claim 11, wherein the operating parameters included in the advertising channel messages enable a receiving device to receive the information transmitted on the data channel broadcast connection.

16. An apparatus, comprising:
at least one processor;
at least one memory including computer program code;
the at least one memory and the computer program code configured to, with the at least one processor, cause the apparatus at least to:
receive, by an apparatus, one or more non-connectable undirected advertising channel messages;
determine, at the apparatus, whether the one or more non-connectable undirected advertising channel messages include an indication of a data channel broadcast connection and operating parameters associated with the data channel broadcast connection;
adopt the operating parameters from the one or more received advertising messages when the one or more non-connectable undirected advertising channel messages include an indication of a data channel broadcast connection and operating parameters associated with the data channel broadcast connection; and
receive information on the data channel broadcast connection according to the operating parameters associated with the data channel broadcast connection.

17. The apparatus of claim 16, wherein the apparatus is in receive-only mode while receiving the information on the data channel broadcast connection.

18. The apparatus of claim 16, wherein the advertising channel message is received on a Bluetooth Low Energy advertising channel and the information is received on a Bluetooth Low Energy data channel.

19. The apparatus of claim 16, wherein the operating parameters associated with the data channel broadcast connection included in the one or more advertising channel messages enable the apparatus to receive the information on the data channel broadcast connection.

20. The apparatus of claim 16, wherein the operating parameters included in the advertising channel messages enable the apparatus to synchronize to the data channel broadcast connection to receive the information on the data channel broadcast connection.

21. A computer program product comprising computer executable program code recorded on a computer readable non-transitory storage medium, the computer executable program code comprising:
code for creating, at an apparatus, operating parameters for a data channel broadcast connection;
code for transmitting, by the apparatus, one or more non-connectable undirected advertising channel messages indicating the data channel broadcast connection and the operating parameters associated with the data channel broadcast connection; and
code for transmitting, by the apparatus, information on the data channel broadcast connection according to the operating parameters associated with the data channel broadcast connection.

22. A computer program product comprising computer executable program code recorded on a computer readable non-transitory storage medium, the computer executable program code comprising:
code for receiving, by an apparatus, one or more non-connectable undirected advertising channel messages;
code for determining, at the apparatus, whether the one or more non-connectable undirected advertising channel messages include an indication of a data channel broadcast connection and operating parameters associated with the data channel broadcast connection;
code for adopting the operating parameters from the one or more received advertising messages when the one or more non-connectable undirected advertising channel messages include an indication of a data channel broadcast connection and operating parameters associated with the data channel broadcast connection; and code for receiving information on the data channel broadcast connection according to the operating parameters associated with the data channel broadcast connection.
